(19) United States
(12) Patent Application Publication
(10) Pub. No.: US 2026/0275152 A1
(43) Pub. Date: Sep. 17, 2026

(54) EPOXY RESIN COMPOSITION, VARNISH, INORGANIC COMPOSITE SHEET, AND METAL-BASED SUBSTRATE

(71) Applicant: DIC Corporation, Tokyo (JP)

(72) Inventors: Hiroshi YAMAMOTO, Chiba (JP); Keisuke MATSUURA, Tokyo (JP); Akira FUJITA, Chiba (JP); Masamichi YOSHIWARA, Chiba (JP); Kazuo ITOYA, Chiba (JP); Masaki IIDA, Chiba (JP)

(73) Assignee: DIC Corporation, Tokyo (JP)

(21) Appl. No.: 19/469,383

(22) PCT Filed: Mar. 21, 2024
(86) PCT No.: PCT/JP2024/010919

§ 371 Date: Sep. 26, 2025

(30) Foreign Application Priority Data
Apr. 4, 2023 (JP) 2023-060673

(51) Int. Cl. C09D 163/00; B32B 15/092; B32B 27/20; B32B 27/26; B32B 27/38; C08K 3/22; C08K 5/315; C08K 9/00; C08L 63/00; C09D 7/61

(52) U.S. Cl. CPC C09D 163/00; B32B 15/092; B32B 27/20; B32B 27/26; B32B 27/38; C08K 3/22; C08K 5/3155; C08K 9/00; C08L 63/00; C09D 7/61; B32B 2250/02; B32B 2250/40; B32B 2255/10; B32B 2255/26; B32B 2264/1023; B32B 2264/104; B32B 2307/202; B32B 2307/7376; C08K 2003/2227; C08K 2201/005; C08L 2205/025

(57) ABSTRACT

Provided is an epoxy resin composition containing an epoxy resin (A), alumina (B), and aggregated boron nitride (C), wherein the alumina (B) is a polyhedron with 14 or more faces.

### TECHNICAL FIELD

The present invention relates to a thermosetting resin composition, a sheet, and a metal-based substrate.

### BACKGROUND ART

In recent years, with the demand for miniaturization, high frequency, and high output of electronic devices, manufacturing of printed wiring boards by a build-up method has been actively performed in order to achieve high integration of semiconductors, miniaturization of the printed wiring boards, and the like. These printed wiring boards are required to have high heat dissipation performance, and development of using a material excellent in thermal conductivity is progressing.

For example, Patent Document 1 discloses an epoxy resin composition containing an epoxy resin monomer, a curing agent, and a filler, wherein the filler contains a first filler containing boron nitride particles in which D50 is 20 μm or more and an average of aspect ratios of primary particles is 30 or less, or an aggregate of the boron nitride particles, and a second filler containing boron nitride particles in which D50 is less than 10 μm and the average aspect ratio is 5 or less, or an aggregate of the boron nitride particles.

Patent Document 2 discloses a resin composition containing an aluminum oxide (A) containing molybdenum and a resin (B), wherein the aluminum oxide (A) has an average particle diameter of 1000 μm or less. In addition, it is shown that the shape of the aluminum oxide (A) is not limited and is a true sphere or a polyhedral particle.

Patent Document 3 discloses an epoxy resin composition containing an epoxy resin monomer, a curing agent containing a novolac resin obtained by converting a divalent phenol compound into a novolac, and a mixed filler of α-alumina and boron nitride.

### CITATION LIST

### Patent Literature

Patent Document 1: JP 2021-165401 A
Patent Document 2: WO 2015/060125
Patent Document 3: JP 2016-155985 A

### SUMMARY OF INVENTION

### Technical Problem

As shown in Patent Documents 1 and 2, for the purpose of imparting high thermal conductivity, resin compositions to which boron nitride or alumina is added as a filler have been widely studied. However, in all the documents, the main thing is to add the same kind of filler, and there are not many studies focusing on the effect obtained by using different kinds of fillers in combination.

Patent Document 3 discloses a resin composition in which two kinds of fillers of α-alumina and boron nitride are used in combination. In particular, attention is paid to a structure of an epoxy resin monomer. By using an epoxy resin monomer having a characteristic structure, a cured product having a high-order structure with high order centered on alumina can be obtained, and excellent thermal conductivity is exhibited. The α-alumina to be used is not particularly limited as long as the particle size is disclosed, and is insufficient as a study focusing on the filler.

Although it is required to form a fine wiring circuit due to high integration of a semiconductor, miniaturization of a printed wiring board, and the like, when a fine roughened shape is formed, there is a problem that adhesion, that is, peel strength is reduced; however, it is not mentioned in any of the above documents, and further improvement is required.

From the above, an object of the present invention is to provide a resin composition having all of thermal conductivity, insulation reliability, and peel strength, a varnish, an inorganic composite sheet thereof, and a metal-based substrate.

### Solution to Problem

The present inventors have conducted intensive studies in order to solve the above problems. As a result, the present inventors have found that when an epoxy resin, alumina, and aggregated boron nitride are contained, and the alumina is a polyhedron with 14 or more faces, a resin composition having all of thermal conductivity, insulation reliability, and peel strength can be obtained.

That is, the present invention includes the following aspects.
(1) An epoxy resin composition containing: an epoxy resin (A); alumina (B); and aggregated boron nitride (C), wherein the alumina (B) is a polyhedron with 14 or more faces.
(2) A varnish containing the epoxy resin composition described in 1 above.
(3) An inorganic composite sheet produced by applying the varnish described in 2 above to a carrier material, and forming a layer of the varnish to have a thickness of from 100 to 200 μm in an uncured state.
(4) A metal-based substrate produced by lamination molding of the inorganic composite sheet described in 3 above.

### Advantageous Effects of Invention

The resin composition of the present invention is excellent in thermal conductivity and insulation reliability by using alumina having a specific shape and aggregated boron nitride, and can be suitably used for a high thermal conductivity printed wiring board material and the like.

### DESCRIPTION OF EMBODIMENTS

Hereinafter, an embodiment of the present invention will be described in detail. The present invention is not limited by the following embodiment, and modification can be appropriately applied in a range that does not impair the effect of the present invention.

### <Epoxy Resin Composition>

An epoxy resin composition of the present embodiment contains an epoxy resin (A), alumina (B), and aggregated boron nitride (C), and the alumina (B) is a polyhedron with 14 or more faces.

### [Epoxy Resin (A)]

In the present embodiment, the epoxy resin (A) is not particularly limited, and is preferably one that is suitably used as a semiconductor sealing material. For example, bisphenol A type epoxy resin, bisphenol F type epoxy resin, bisphenol S type epoxy resin, bisphenol AD type epoxy resin, phenol novolac type epoxy resin, orthocresol novolac type epoxy resin, naphthalene skeleton-containing epoxy resin, biphenyl skeleton-containing epoxy resin, linear aliphatic epoxy resin, alicyclic epoxy resin, heterocyclic epoxy resin, and the like are suitable. From the viewpoint of melt viscosity, an orthocresol novolac type epoxy resin, a bisphenol type epoxy resin, and a biphenyl skeleton-containing epoxy resin are preferable, and from the viewpoint of moisture resistance and solder reflow resistance, an orthocresol novolac type epoxy resin is preferable. From the viewpoint of handleability of a B-stage sheet, a phenol biphenyl aralkyl epoxy resin having a softening temperature of 80° C. or lower is preferable.

These epoxy resins may be used singly or in combination of two or more kinds thereof.

In the present embodiment, a blending amount of the epoxy resin in the resin composition is preferably from 3 mass % to 15 mass %, and more preferably from 4 mass % to 12 mass %, with respect to a total mass of the resin composition. When the blending amount is from 4 mass % to 12 mass %, the resulting epoxy resin composition is excellent in moldability, and when a cured product is formed, the cured product has a high thermal conductivity, which is preferable.

In the present embodiment, a curing agent can be further contained. The curing agent can be used without particular limitation as long as it is capable of curing reaction with the epoxy resin, and examples thereof include phenol resins, amine-based compounds, amide-based compounds, acid anhydride-based compounds, cyanate ester compounds, compounds having an unsaturated double bond-containing substituent, and diene-based polymers.

Examples of the curing agent for the phenol resin include polyhydric phenolic novolac resins synthesized from a polyhydric hydroxy compound and formaldehyde, which are typified by a phenolic novolac resin, a cresol novolac resin, an aromatic hydrocarbon formaldehyde resin-modified phenolic resin, a dicyclopentadiene phenol addition-type resin, a phenolic aralkyl resin (Xylok resin) and a resorcin novolac resin and polyhydric phenolic compounds and polyhydric phenolic compounds, such as a naphtholaralkyl resin, a tetraphenylolethane resin, a naphthol novolac resin, a naphthol-phenol cocondensed novolac resin, a naphthol-cresol cocondensed novolac resin, a biphenyl-modified phenolic resin (a polyhydric phenolic compound having a phenol nucleus connected through a bismethylene group), a biphenyl-modified naphthol resin (a polyhydric naphthol compound having a phenol nucleus connected through a bismethylene group), an aminotriazine-modified phenolic resin (a polyhydric phenolic compound having a phenol nucleus connected through melamine, benzoguanamine or the like) and an alkoxy group-containing aromatic ring-modified novolac resin (a polyhydric phenolic compound having a phenol nucleus and an alkoxy group-containing aromatic ring connected through formaldehyde).

Examples of the amine-based compound include diaminodiphenylmethane, diethylenetrimine, triethylenetetramine, diaminodiphenylsulfone, isophoronediamine, imidazole, BF₃-amine complexes, and guanidine derivatives.

Examples of the amide-based compound include dicyandiamide and a polyamide resin synthesized from a dimer of linolenic acid and ethylenediamine.

Examples of the acid anhydride-based compound include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the cyanate ester compound include a bisphenol A type cyanate ester resin, a bisphenol F type cyanate ester resin, a bisphenol E type cyanate ester resin, a bisphenol S type cyanate ester resin, a bisphenol sulfide type cyanate ester resin, a phenylene ether type cyanate ester resin, a naphthylene ether type cyanate ester resin, a biphenyl type cyanate ester resin, a tetramethyl biphenyl type cyanate ester resin, a polyhydroxynaphthalene type cyanate ester resin, a phenol novolac type cyanate ester resin, a cresol novolac type cyanate ester resin, a triphenylmethane type cyanate ester resin, a tetraphenylethane type cyanate ester resin, a dicyclopentadiene-phenol addition reaction type cyanate ester resin, a phenol aralkyl type cyanate ester resin, a naphthol novolac type cyanate ester resin, a naphthol aralkyl type cyanate ester resin, a naphthol-phenol co-condensed novolac type cyanate ester resin, a naphthol-cresol co-condensed novolac type cyanate ester resin, an aromatic hydrocarbon formaldehyde resin-modified phenolic resin type cyanate ester resin, a biphenyl-modified novolac type cyanate ester resin, and an anthracene type cyanate ester resin.

The compound having an unsaturated double bond-containing substituent is not particularly limited as long as it is, for example, a compound having two or more unsaturated bond-containing substituents in the molecule, and examples of the unsaturated bond-containing substituent include compounds having an allyl group, an isopropenyl group, a 1-propenyl group, an acryloyl group, a methacryloyl group, a styryl group, a styrylmethyl group, and the like.

Examples of the diene-based polymer include a non-modified diene-based polymer that is not modified with a polar group. Here, the polar group is a functional group that affects dielectric characteristics, and examples thereof include a phenol group, an amino group, and an epoxy group. The diene-based polymer is not particularly limited, and for example, 1,2-polybutadiene or 1,4-polybutadiene can be used.

As the diene-based polymer, a homopolymer of butadiene in which 50% or more of butadiene units in a polymer chain are 1,2-bonds and a derivative thereof can also be used.

As the amount of the curing agent used relative to the amount of the epoxy resin used, a ratio (epoxy equivalent/active hydrogen equivalent) of an epoxy equivalent of the epoxy resin to an active hydrogen equivalent of the curing agent is more preferably from 0.7 to 1.3, and more preferably from 0.8 to 1.2. When the (epoxy equivalent/active hydrogen equivalent) is out of the above range, a cured product to be obtained may cause curing failure.

In the present embodiment, a curing accelerator can be further contained. The curing accelerator can be contained for the purpose of accelerating the curing reaction between the epoxy resin and the curing agent, and examples thereof include a phosphorus-based curing accelerator, an amine-based curing accelerator, an imidazole-based curing accelerator, a guanidine-based curing accelerator, and a urea-based curing accelerator. The curing accelerators may be used alone, or two or more types may be used in combination.

Examples of the phosphorus-based curing accelerator include organic phosphine compounds such as triphenylphosphine, tributylphosphine, triparatolylphosphine, diphenylcyclohexylphosphine, and tricyclohexylphosphine; organic phosphite compounds such as trimethylphosphite and triethylphosphite; and phosphonium salts such as ethyltriphenylphosphonium bromide, benzyltriphenylphosphonium chloride, butylphosphonium tetraphenylborate, tetraphenylphosphonium tetraphenylborate, tetraphenylphosphonium tetra-p-tolylborate, triphenylphosphine triphenylborane, tetraphenylphosphonium thiocyanate, tetraphenylphosphonium dicyanamide, butylphenylphosphonium dicyanamide, and tetrabutylphosphonium decanoate.

Examples of the amine-based curing accelerator include triethylamine, tributylamine, N, N-dimethyl-4-aminopyridine (4-dimethylaminopyridine, DMAP), 2,4,6-tris (dimethylaminomethyl) phenol, 1,8-diazabicyclo[5.4.0]-undecene-7 (DBU), and 1,5-diazabicyclo[4.3.0]-nonene-5 (DBN).

Examples of the imidazole-based curing accelerator include 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2-phenylimidazole isocyanuric acid adduct, 2-phenyl-4,5-dihydroxymethylimidazole, 2-phenyl-4-methyl-5 hydroxymethylimidazole, 2,3-dihydro-1H-pyrrolo[1,2-a]benzimidazole, 1-dodecyl-2-methyl-3-benzylimidazolium chloride, and 2-methylimidazoline.

Examples of the guanidine-based curing accelerator include dicyandiamide, 1-methylguanidine, 1-ethylguanidine, 1-cyclohexylguanidine, 1-phenylguanidine, dimethylguanidine, diphenylguanidine, trimethylguanidine, tetramethylguanidine, pentamethylguanidine, 1,5,7-triazabicyclo[4.4.0]deca-5-ene, 7-methyl-1,5,7-triazabicyclo[4.4.0]deca-5-ene, 1-methylbiguanide, 1-ethylbiguanide, 1-butylbiguanide, 1-cyclohexylbiguanide, 1-allylbiguanide, and 1-phenylbiguanide.

Examples of the urea-based curing accelerator include 3-phenyl-1,1-dimethylurea, 3-(4-methylphenyl)-1,1-dimethylurea, chlorophenylurea, 3-(4-chlorophenyl)-1,1-dimethylurea, and 3-(3,4-dichlorophenyl)-1,1-dimethylurea.

Among the curing accelerators, a phosphorus-based curing accelerator and an imidazole-based curing accelerator are preferably used from the viewpoint of curability, and the phosphorus-based curing accelerator is particularly preferable from the viewpoint of insulation reliability.

The amount of the curing accelerator used can be appropriately adjusted in order to obtain desired curability, and is preferably from 0.01 to 10 parts by mass, and more preferably from 0.1 to 5 parts by mass, with respect to 100 parts by mass of a total amount of a mixture of the epoxy resin and the curing agent. When the amount of the curing accelerator used is within the above range, the curability and the insulation reliability are excellent, which is preferable.

### [Alumina (B)]

In the present embodiment, the “alumina” is aluminum oxide and may be any of various types of transition alumina that have a crystalline form such as γ, δ, θ, or κ, or may contain an alumina hydrate in the transition alumina, and it is basically preferably an α-crystal form in terms of more excellent stability.

The shape of the alumina is preferably a polyhedral shape, and is particularly a polyhedral shape having 14 or more faces. The polyhedron with 14 or more faces is preferable because an opportunity for surface contact is significantly improved and excellent thermal conductivity is obtained as compared with a polyhedron with less than 14 faces.

The shape of alumina can be confirmed by a scanning electron microscope (SEM). Using JCM7000 available from JEOL Ltd., an image obtained by a plurality of SEM images from any visual field of a sample is observed. Then, with respect to observation results of 50 alumina particles randomly selected, the shape of 60% or more of the particles on the number basis can be determined as the shape of the sample.

The average particle diameter of the alumina (B) in the present embodiment is preferably 25 μm or more and 45 μm or less. When the average particle diameter is 25 μm or more, an increase in viscosity when a varnish is formed is suppressed, which is preferable. When the average particle diameter is 45 μm or less, sheet processability is excellent, which is preferable.

The “average particle diameter” referred to in the present invention is a value calculated as a volume-based median diameter D50 from a volume-based cumulative particle size distribution, which is measured by a laser diffraction/scattering particle size distribution analyzer.

The content of the alumina (B) in the epoxy resin composition of the present embodiment may be from 30 to 80 parts by mass or may be from 40 to 70 parts by mass in 100 parts by mass of a total solid content of the epoxy resin composition. A suitable content of the alumina (B) can be set according to the content of the aggregated boron nitride (C) described later.

As the alumina (B) of the present embodiment, commercially available alumina particles may be used, or alumina particles produced by the method described in JP 2016-028993 A and WO 2021/070729 A may be used.

Examples of commercially available alumina particles include DAW45 (available from Denka Company Limited), CB-A20S, CB-AS30S, CB-P15 (available from Showa Denko K.K.), AZ series (available from NIPPON STEEL Chemical & Material Co., Ltd.), AH40-S (available from DIC Corporation), and AO-502 (available from Admatechs). From the viewpoint of fluidity, CB-A20S, CB-A30S, CB-P15 (available from Showa Denko K.K.) and AO-502 (available from Admatechs) are preferable, and from the viewpoint of thermal conductivity, AH40-S (available from DIC Corporation) is preferable, but is not limited thereto.

These alumina particles may be used alone or in combination of two or more, and it is preferable to use a combination of two or more. When a plurality of the alumina particles are used in combination, polyhedral alumina particles are contained preferably in an amount of 50 mass % or more and more preferably in an amount of 60 mass % or more in the total alumina (B). Within the above range, the thermal conductivity of an inorganic composite sheet to be obtained and a metal-based substrate to be obtained is particularly excellent, which is preferable.

### [Aggregated Boron Nitride (C)]

The aggregated boron nitride (C) of the present embodiment is aggregated boron nitride in which scaly boron nitride is randomly oriented. Use of the aggregated boron nitride (C) is preferable because orientation of boron nitride in a plane direction is suppressed, and the thermal conductivity in a thickness direction is improved when the inorganic composite sheet described later is formed.

The average particle diameter of the aggregated boron nitride (C) is preferably 5 μm or more and 50 μm or less, and more preferably 10 μm or more and 40 μm or less. When the average particle diameter is 5 μm or more, an increase in viscosity is suppressed, and when the average particle diameter is 50 μm or less, the moldability is excellent, which is preferable.

A specific surface area of the aggregated boron nitride (C) may be from 1 to 4 cm²/g and preferably from 1.5 to 3.5 cm²/g. When the specific surface area is within the above range, the increase in viscosity is suppressed, which is preferable. The specific surface area is determined by a BET method.

Particle strength of the aggregated boron nitride (C) may be 20 MPa or less, is preferably 18 MPa or less, and particularly preferably 15 MPa or less. When the particle strength is 20 MPa or less, an air content in a heat dissipation sheet is suppressed, and the thermal conductivity can be improved. When the particle strength is 5 MPa or more, breakage of the aggregated boron nitride is suppressed in a production process, which is preferable.

The particle strength can be measured in accordance with JIS R1639-5:2007. After aggregated boron nitride particles are sprayed on a sample stage of a micro compression tester (“MCT-W 500” available from Shimadzu Corporation), 5 aggregated boron nitride particles are selected, and a crushing test is performed on each particle to calculate the particle strength. The particle strength (σ: MPa) was calculated from a dimensionless number (α=2.48) that varies depending on a position in the particle, a crushing test force (P:N), and the particle diameter (d: μm) using the formula σ=α× P/(π×d2). Crushing strength of 5 inorganic filler components is subjected to Weibull plotting in accordance with JIS R1625:2010, and the crushing strength at which a cumulative fracture rate is 63.2% is defined as the particle strength of the aggregated boron nitride particles.

As the aggregated boron nitride (C) of the present embodiment, commercially available products can be used, and examples thereof include HP-40MF, HP40-J2 (available from Mizushima Ferroalloy Co., Ltd.), PTX60 (available from Momentive), and Agglomerates 50 (available from 3M). Preferred are HP-40MF and HP40-J2 (available from Mizushima Ferroalloy Co., Ltd.) fired to from an aggregate without internal voids.

The content of the aggregated boron nitride (C) in the epoxy resin composition of the present embodiment may be from 10 to 75 parts by mass, and is preferably from 40 to 70 parts by mass in 100 parts by mass of a total solid content of the epoxy resin composition.

A total content of the alumina (B) and the aggregated boron nitride (C) in the epoxy resin composition of the present embodiment may be from 70 to 95 parts by mass, and is preferably from 75 to 90 parts by mass in 100 parts by mass of a total solid content of the epoxy resin composition. Within the above range, an increase in viscosity of the epoxy resin composition or the varnish thereof can be suppressed, and a uniform coating film can be formed.

Within the above range, the contents of the alumina (B) and the aggregated boron nitride (C) may be any combination, and a mass ratio of the alumina (B) and the aggregated boron nitride (C) may be from 50:50 to 95:5, preferably from 55:45 to 90:10, and particularly preferably from 60:40 to 85:15. Within the above range, both the thermal conductivity and the insulation reliability can be achieved at an excellent level, which is preferable.

By combining the alumina (B) and the aggregated boron nitride (C), it is possible to obtain more excellent thermal conductivity than ever before, and thus it is possible to reduce a filling amount in the epoxy resin composition. By reducing the filling amount, a dielectric breakdown voltage of the epoxy resin composition increases, in addition, a variation in the dielectric breakdown voltage is suppressed, and the electrical characteristics can be stabilized.

### <Varnish>

The present invention relates to a varnish containing the epoxy resin composition. As a method for preparing the varnish, a known method can be used, and the epoxy resin composition can be dissolved (diluted) in an organic solvent to form a varnish.

As the solvent, for example, a polar solvent such as methyl ethyl ketone, methoxypropanol, N, N-dimethylformamide, or dimethyl sulfoxide can be used, and the solvent may be used alone or in combination of two or more.

The amount of the solvent used is not particularly limited, and can be appropriately determined in consideration of sheet processability, for example. Specifically, the viscosity of the varnish to be obtained is preferably adjusted to be from 3000 mPa·s to 15000 mPa·s. When the viscosity is 3000 mPa·s or more, an appearance defect due to repelling during coating is suppressed, which is preferable. When the viscosity is 15000 mPa·s or less, an appearance defect due to streak unevenness during coating is suppressed, which is preferable.

### [Other Components]

The varnish of the present embodiment can contain other components as long as the object of the present invention is not impaired. Examples thereof include a silane coupling agent and a dispersant.

Examples of the silane coupling agent include epoxysilane.

The dispersant is not particularly limited as long as it is a dispersant used for coating, and examples thereof include Disperbyk-110, 111, 180, and 161, and BYK-W996, W9010, and W903. By using the dispersant, not only the dispersibility of the alumina (B) is improved, but also the viscosity of the varnish can be adjusted to fall within the above-described range.

### <Inorganic Composite Sheet>

The varnish of the present invention is suitably used for an inorganic composite sheet. The inorganic composite sheet is obtained by applying the above-described varnish to a carrier material and heating and drying the varnish. The inorganic composite sheet is formed in a semi-cured state on a surface of the carrier material. That is, the heating and drying means bringing into the B-stage, and the reaction of the epoxy resin in the varnish is partially performed by heating the varnish applied to the carrier material. Therefore, the inorganic composite sheet of the present embodiment has a property of temporarily melting and then curing by heating and pressurization in lamination molding.

A method for applying the varnish is not particularly limited, and the varnish can be applied by a known method. Examples thereof include comma coating, die coating, lip coating, and gravure coating. As a method for forming an inorganic composite sheet having a predetermined thickness, a comma coating method in which an object to be coated is passed between gaps, a die coating method in which a varnish with a flow rate adjusted from a nozzle is applied, or the like is preferable.

A thickness of the inorganic composite sheet formed on the carrier material is preferably from 100 to 200 μm. When the thickness is 100 μm or more, thermal resistance decreases, which is preferable. As the thickness approaches 200 μm, the dielectric breakdown voltage increases, which is preferable.

As the carrier material, a polymer film or a metal sheet is preferably used. Examples of the polymer film include polyolefins such as polyethylene, polypropylene, and polyvinyl chloride, polyesters such as polyethylene terephthalate, polycarbonate, acetyl cellulose, and tetrafluoroethylene. Examples of the metal sheet include metal sheets, for example, metal foils such as a copper foil, an aluminum foil, and a nickel foil. In addition, examples of the carrier material include release paper.

### <Metal-Based Substrate>

The inorganic composite sheet of the present invention can be suitably used for a metal-based substrate through lamination molding. Specifically, two or more of the inorganic composite sheets obtained as described above are laminated to have a desired thickness, a metal foil is then disposed on an outermost layer on one side or both sides of the resulting laminate to form a laminated product, and the laminated product is integrated by heating and pressurization such as press molding to produce the metal-based substrate. Here, for the metal foil, copper, aluminum, brass, nickel or the like can be used alone, or an alloy or composite metal foil can be used. As the conditions for heating and pressurizing the laminate, the laminate may be heated and pressurized by appropriately adjusting under the conditions under which the varnish of the present invention is cured; however, if the pressure of pressurization is too low, air bubbles may remain in the metal-based substrate to be obtained, and the electrical characteristics may be deteriorated. Therefore, it is preferable to pressurize the laminate under the conditions satisfying moldability. For example, the metal-based substrate can be obtained by performing thermocompression molding under the conditions of a heating temperature of from 100 to 200° C. and a pressure of from 0.98 to 4.9 MPa for from 10 minutes to 2 hours to perform integral molding.

The epoxy resin composition of the present invention has both the insulation reliability and the thermal conductivity, and the inorganic composite sheet containing them can be suitably used for printed wiring boards such as semiconductor wafers, high brightness LEDs, and heat dissipation substrates on which power semiconductor devices and the like are mounted.

### EXAMPLES

Next, the present invention will be specifically described with reference to Examples and Comparative Examples, but the present invention is not limited thereto.

### (Evaluation of Viscosity)

The viscosity (25° C.) of the varnish obtained in Examples and Comparative Examples described later was measured using an E-type viscometer TVE-20H (available from TOKISANGYO).

### (Evaluation of Thermal Conductivity)

A metal-based substrate obtained in Examples and Comparative Examples described later was cut into a 1 cm square, and then carbon black was sprayed on both surfaces to prepare a measurement sample. Using the obtained measurement sample, the thermal conductivity was calculated by a laser flash method.

### (Evaluation of 90 Degree Peel Strength (Peel Strength))

The metal-based substrate obtained in Examples and Comparative Examples described later was cut into a size of 50 mm×120 mm to obtain a test sample. A copper foil was peeled off so that the copper foil having a center width of 10 mm of the obtained test sample remained, and peel strength of the copper foil having a center width of 10 mm was measured in accordance with JIS C 6481. As a peel strength measuring apparatus, “Autograph” available from Shimadzu Corporation was used. The peel strength of the copper foil was measured for 20 test samples. An average value of measured values of the peel strength of the copper foil in the 20 test samples was defined as a 90 degree peel strength.

### (Long-Term Insulation Reliability)

The copper foil in the metal-based substrate obtained in Examples and Comparative Examples described later was etched to pattern the copper foil into a circle having a diameter of 2.5 cm, thereby obtaining a test sample. Using 20 obtained test samples, an AC voltage of 3 kV was applied between the test samples for 1000 hours under an environment of a temperature of 85° C. and a humidity of 85%, and whether or not dielectric breakdown occurred was evaluated. The long-term insulation reliability was determined according to the following criteria.

### [Criteria for Judgment in Long-Term Insulation Reliability]

∘: 0 test sample in which dielectric breakdown occurred
Δ: 1 or more and less than 10 test samples in which dielectric breakdown occurred
x: 10 or more test samples in which dielectric breakdown occurred

### Examples 1 to 3, Comparative Examples 1 to 3

Epoxy resin, alumina, and aggregated boron nitride shown below were used as raw materials, and a resin composition was prepared with the formulation shown in Table 1 and used as a varnish as it was.

### [Epoxy Resin (A)]

EPICLON 850 (available from DIC Corporation, bisphenol A type epoxy resin) NC-3000 (available from Nippon Kayaku Co., Ltd., phenol biphenyl aralkyl epoxy resin)
VG-3101 (available from Printec Co., trifunctional epoxy resin)

### [Alumina (B)]

AH40-S (available from DIC Corporation, average particle diameter: 32 μm, 14-hedron)
DAW45FC (available from Denka Company Limited, average particle diameter: 36 μm)

### [Aggregated Boron Nitride (C)]

HP-40MF (available from Mizushima Ferroalloy Co., Ltd., average particle diameter: 36 μm)
HP40-J2 (available from Mizushima Ferroalloy Co., Ltd., average particle diameter: 16 μm)

### [Other Components]

YP50 (available from NIPPON STEEL Chemical & Material Co., Ltd., phenoxy resin)
Dicyandiamide (available from NIPPON CARBIDE INDUSTRIES CO., INC., curing agent)
2E4MZ (available from SHIKOKU CHEMICALS CORPORATION, curing accelerator)
BYK-W903 (available from BYK Japan KK., dispersant)
KBE-403 (available from Shin-Etsu Chemical Co., Ltd., coupling agent, γ-glycidoxypropyltriethoxysilane)

### (Preparation of Metal-Based Substrate)

The obtained varnish was kneaded with a planetary mixer, and a predetermined amount of a solvent (mixed solution of methyl ethyl ketone and dimethylformamide) was blended to obtain a varnish having a viscosity adjusted to 3000 mPa·s. Next, this varnish was applied to a polyethylene terephthalate (PET) film having a thickness of 75 μm, and heated and dried at 130° C. for 8 minutes to form an inorganic composite sheet in a B-stage state having a thickness of 150 μm on one surface of the carrier material.

10 sheets of the obtained inorganic composite sheets were laminated, and 18 μm copper foils were arranged on both sides, and subjected to thermocompression molding in a vacuum at a heating temperature of 175° C. and a pressing force of 2.94 MPa for 90 minutes, thereby preparing a metal-based substrate.

The evaluation results of the varnish and the metal-based substrate obtained above are shown in Table 1.

TABLE 1

| | | Example | Example | Example | Comparative | Comparative | Comparative |
|---|---|---|---|---|---|---|---|
| | | 1 | 2 | 3 | Example 1 | Example 2 | Example 3 |
| Alumina (B) | AH40-S | 50 | 25 | 75 | | | 100 |
| | DAW45FC | | | | | 50 | |
| Aggregated | HF40 MF | 50 | 75 | 25 | 100 | 50 | |
| boron nitride | | | | | | | |
| (C) | | | | | | | |
| TOTAL | | 100 | 100 | 100 | 100 | 100 | 100 |
| Amount of | In varnish solid | 85 | 85 | 85 | 85 | 85 | 85 |
| alumina to be | content | | | | | | |
| charged | (mass %) | | | | | | |
| Epoxy resin | EPICLON 850 | 35 | 35 | 35 | 35 | 35 | 35 |
| (A) | NC-3000 | 20 | 20 | 20 | 20 | 20 | 20 |
| | VG-3101 | 10 | 10 | 10 | 10 | 10 | 10 |
| Phenoxy | YP50 | 1.6 | 1.6 | 1.6 | 1.6 | 1.6 | 1.6 |
| resin | | | | | | | |
| Curing agent | Dicyandiamide | 3.3 | 3.3 | 3.3 | 3.3 | 3.3 | 3.3 |
| Curing | 2E4MZ | 0.1 | 0.1 | 0.1 | 0.1 | 0.1 | 0.1 |
| accelerator | | | | | | | |
| Dispersant | BYK-W903 | 15 | 15 | 15 | 15 | 15 | 15 |
| Silane | KBE-403 | 15 | 15 | 15 | 15 | 15 | 15 |
| coupling | | | | | | | |
| agent | | | | | | | |
| TOTAL | | 100 | 100 | 100 | 100 | 100 | 100 |
| Thermal | W/m · K | 9 | 12 | 6 | 15 | 7 | 2 |
| conductivity | | | | | | | |
| Peel strength | kN/m | 1 | 0.8 | 1.2 | 0.5 | 1.1 | 1.2 |
| Insulation | | ∘ | Δ | ∘ | x | Δ | ∘ |
| reliability | | | | | | | |

1. An epoxy resin composition comprising:
an epoxy resin (A);
alumina (B); and
aggregated boron nitride (C),
wherein the alumina (B) is a polyhedron with 14 or more faces.

2. A varnish comprising the epoxy resin composition described in claim 1.

3. An inorganic composite sheet produced by applying the varnish described in claim 2 to a carrier material, and forming a layer of the varnish to have a thickness of from 100 to 200 μm in an uncured state.

4. A metal-based substrate produced by lamination molding of the inorganic composite sheet described in claim 3.
